(19) United States
(12) Patent Application Publication
(10) Pub. No.: US 2025/0362862 A1
(43) Pub. Date: Nov. 27, 2025

(54) INFORMATION PROCESSING METHOD, INFORMATION PROCESSING DEVICE, ACOUSTIC REPRODUCTION SYSTEM, AND RECORDING MEDIUM

(71) Applicant: Panasonic Intellectual Property Management Co., Ltd., Osaka (JP)

(72) Inventors: Akiko FUJISE, Osaka (JP); Mitsuko SHUTO, Osaka (JP); Saeko SHINGU, Osaka (JP)

(21) Appl. No.: 19/297,361

(22) Filed: Aug. 12, 2025

Related U.S. Application Data
(63) Continuation of application No. PCT/JP2024/003630, filed on Feb. 5, 2024.

(30) Foreign Application Priority Data
Feb. 20, 2023 (JP) 2023-024376

(51) Int. Cl. G06F 3/16; G06T 15/00

(52) U.S. Cl. CPC G06F 3/16; G06T 15/00

(57) ABSTRACT

An information processing method includes: obtaining sound information capable of identifying a virtual sound image to be perceived by a user via an output sound signal; obtaining real sound image occurrence information related to an occurrence of a real sound image, which is a sound image in a real space where the user is located; calculating a degree of importance of the virtual sound image to be perceived by the user based on the obtained sound information; calculating a degree of importance of the real sound image related to the obtained real sound image occurrence information; comparing the calculated degree of importance of the virtual sound image and the calculated degree of importance of the real sound image; and adjusting an effect amount indicating a perception level at which the virtual sound image is to be perceived by the user, based on the comparison result.

### CROSS REFERENCE TO RELATED APPLICATIONS

This is a continuation application of PCT International Application No. PCT/JP2024/003630 filed on Feb. 5, 2024, designating the United States of America, which is based on and claims priority of Japanese Patent Application No. 2023-024376 filed on Feb. 20, 2023. The entire disclosures of the above-identified applications, including the specifications, drawings, and claims are incorporated herein by reference in their entirety.

### FIELD

The present disclosure relates to an acoustic reproduction system, and an information processing method, information processing device, and recording medium related to the acoustic reproduction system.

### BACKGROUND

Techniques for acoustic reproduction to cause a user to perceive three-dimensional sound in a virtual three-dimensional space by controlling the position of a sound image, which is a perceptual sound source object, are known (see, for example, Patent Literature (PTL) 1).

### CITATION LIST

### Patent Literature

PTL 1: WO 2022/038929

### SUMMARY

### Technical Problem

However, when causing a user to perceive sound as three-dimensional sound in a three-dimensional sound field, there may be sounds that are difficult to perceive, such as when they mix with sounds in the real space. In conventional information processing methods in acoustic reproduction devices and the like, appropriate processing may not have been performed for such sounds that are difficult to perceive.

In view of the above, the present disclosure provides an information processing method and the like for causing a user to perceive three-dimensional sound more appropriately.

### Solution to Problem

An information processing method according to one aspect of the present disclosure is for adjusting an output sound signal to cause a user to perceive a virtual sound image, and includes: a first obtaining process of obtaining sound information capable of identifying the virtual sound image to be perceived by the user via the output sound signal; a second obtaining process of obtaining real sound image occurrence information related to an occurrence of a real sound image which is a sound image in a real space where the user is located; a first calculating process of calculating a degree of importance of the virtual sound image to be perceived by the user via the sound information obtained; a second calculating process of calculating a degree of importance of the real sound image related to the real sound image occurrence information obtained; a comparing process of comparing the degree of importance of the virtual sound image calculated and the degree of importance of the real sound image calculated; and an effect amount adjusting process of adjusting an effect amount indicating a perception level at which the virtual sound image is to be perceived by the user, based on a comparison result of the comparing process.

An information processing device according to one aspect of the present disclosure is for adjusting an output sound signal to cause a user to perceive a virtual sound image, and includes: a first obtainer that obtains sound information capable of identifying the virtual sound image to be perceived by the user via the output sound signal; a second obtainer that obtains real sound image occurrence information related to an occurrence of a real sound image which is a sound image in a real space where the user is located; a first calculator that calculates a degree of importance of the virtual sound image to be perceived by the user via the sound information obtained; a second calculator that calculates a degree of importance of the real sound image related to the real sound image occurrence information obtained; a comparator that compares the degree of importance of the virtual sound image calculated and the degree of importance of the real sound image calculated; and an effect amount adjuster that adjusts an effect amount indicating a perception level at which the user is to perceive the virtual sound image, based on a comparison result of the comparator.

An acoustic reproduction system according to one aspect of the present disclosure includes: the information processing device described above; and a driver that reproduces the output sound signal generated.

One aspect of the present disclosure may be realized as a non-transitory computer-readable recording medium for use in a computer, the recording medium having a computer program recorded thereon for causing the computer to execute an information processing method described above.

Note that these general or specific aspects may be implemented using a system, a device, a method, an integrated circuit, a computer program, or a non-transitory computer-readable recording medium such as a CD-ROM, or any combination thereof.

### Advantageous Effects

The present disclosure makes it possible to cause a user to perceive three-dimensional sound more appropriately.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an example of use of an acoustic reproduction system according to an embodiment of the present disclosure.

FIG. 2 is a block diagram illustrating the functional configuration of an acoustic reproduction system according to an embodiment of the present disclosure.

FIG. 3 is a block diagram illustrating the functional configuration of an obtainer according to an embodiment of the present disclosure.

FIG. 4 is a block diagram illustrating the functional configuration of an effect amount adjustment processor according to an embodiment of the present disclosure.

FIG. 5 is a block diagram illustrating the functional configuration of an output sound generator according to an embodiment of the present disclosure.

FIG. 6 is a flowchart illustrating operations performed by an information processing device according to an embodiment of the present disclosure.

FIG. 7 is a diagram for explaining calculation of the degree of importance according to an embodiment of the present disclosure.

FIG. 8 is a diagram for explaining calculation of the degree of importance according to an embodiment of the present disclosure.

FIG. 9 is a diagram for explaining calculation of the degree of importance according to an embodiment of the present disclosure.

FIG. 10 is a diagram for explaining calculation of the degree of importance according to an embodiment of the present disclosure.

FIG. 11 is a flowchart illustrating operations performed by an information processing device according to another example of an embodiment of the present disclosure.

### DESCRIPTION OF EMBODIMENTS

### Underlying Knowledge Forming Basis of the Disclosure

Techniques for acoustic reproduction to cause a user to perceive three-dimensional sound in a virtual three-dimensional space (hereinafter may be referred to as a three-dimensional sound field) by controlling the position of a sound image, which is a sound source object in the user's perception, are known (see, for example, PTL 1). By localizing a sound image at a predetermined position in a virtual three-dimensional space, the user can perceive the sound as if it is arriving from a direction parallel to a straight line connecting the predetermined position and the user (namely, a predetermined direction). In order to localize a sound image at a predetermined position in a virtual three-dimensional space in this way, for example, computational processing is required to generate interaural time differences and interaural level differences (or sound pressure differences) between the ears for the collected sound, such that the sound is perceived as a three-dimensional sound.

As one example of such computational processing, processing that convolves a head-related transfer function for perceiving sound as arriving from a predetermined direction with the signal of the target sound is known. Performing the convolution processing of this head-related transfer function at higher resolution enhances the sense of realism experienced by the user. However, in such a sound listening environment, a phenomenon is known in which sound becomes difficult to hear due to the overlapping of external sound arriving from outside and heard by user 99. For example, in a virtual three-dimensional space generated by the playback of content, many virtual sound images are arranged, and the sound emitted from each of these sound images is perceived as arriving at the user. However, in the real space where the user is located, there are sounds emitted by actual sound images (also referred to as real sound images; in this case, they are accompanied by the existence of actual sound source objects), such as sounds of various household appliances operating, voices emitted by people and animals other than the user who are in the real space, sounds of outdoor moving objects, and natural sounds such as the rustling of trees and wind sounds. As a result, if sound image cancellation that separates the three-dimensional sound field and the real space is not performed, virtual sound images and real sound images will mix together, causing a situation where it becomes difficult for the user to distinguish which sounds are from virtual sound images and which sounds are from real sound images. Stated differently, there may be cases where the user becomes confused (or confounded) because they cannot distinguish between sound images.

In recent years, development of technology related to virtual reality (VR) has been actively conducted. In virtual reality, the focus is placed on enabling the user to experience as if they are moving within the virtual space, without the position of the virtual three-dimensional space following the user's movements. In particular, in this virtual reality technology, attempts are being made to enhance the sense of realism by incorporating auditory elements into visual elements. For example, when a sound image is localized in front of the user, if the user turns to the right, the sound image moves to the left direction of the user, and if the user turns to the left, the sound image moves to the right direction of the user. Thus, with respect to the movement of the user, a need arises to move the localization position of the sound image in the virtual space in the opposite direction to the movement of the user. Such processing is performed by applying a three-dimensional sound filter to the original sound information.

The present disclosure, in a situation where virtual sound images in a three-dimensional sound field and real sound images in real space mix together, makes either the virtual sound images or the real sound images selectively easier to perceive by adjusting an effect amount indicating the perception level at which a user perceives sound emitted from a virtual sound image (hereinafter, also expressed simply as perceiving a virtual sound image; similar expressions are used for real sound images). Thus, information processing is performed to generate an output sound signal that, even when virtual sound images and real sound images mix together, makes the real sound images among them easier to perceive, or makes the virtual sound images among them easier to perceive. The present disclosure provides an information processing method and the like for causing a user to appropriately perceive three-dimensional sound by adjusting the above-described effect amount.

More specifically, an information processing method according to a first aspect of the present disclosure is for adjusting an output sound signal to cause a user to perceive a virtual sound image, and includes: a first obtaining process of obtaining sound information capable of identifying the virtual sound image to be perceived by the user via the output sound signal; a second obtaining process of obtaining real sound image occurrence information related to an occurrence of a real sound image which is a sound image in a real space where the user is located; a first calculating process of calculating a degree of importance of the virtual sound image to be perceived by the user via the sound information obtained; a second calculating process of calculating a degree of importance of the real sound image related to the real sound image occurrence information obtained; a comparing process of comparing the degree of importance of the virtual sound image calculated and the degree of importance of the real sound image calculated; and an effect amount adjusting process of adjusting an effect amount indicating a perception level at which the virtual sound image is to be perceived by the user, based on a comparison result of the comparing process.

According to this information processing method, when a virtual sound image and a real sound image mix together, by calculating and comparing their respective degrees of importance, an output sound signal can be generated such that sound from either the virtual sound image or the real sound image becomes easier to hear by adjusting the effect amount of the virtual sound image according to the comparison result. As a result, even when virtual sound images and real sound images mix together, it is possible to generate an output sound signal that makes the real sound images or the virtual sound images among them easier to perceive, making it possible to cause a user to perceive three-dimensional sound appropriately.

For example, an information processing method according to a second aspect of the present disclosure is the information processing method according to the first aspect, wherein in the effect amount adjusting process, the effect amount is reduced when the comparison result indicates that the degree of importance of the virtual sound image is lower than or equal to the degree of importance of the real sound image.

With this, when the comparison result indicates that the degree of importance of the virtual sound image is lower than or equal to the degree of importance of the real sound image, the effect amount can be adjusted to be reduced, that is, an output sound signal that makes the real sound image easier to perceive can be generated.

For example, an information processing method according to a third aspect of the present disclosure is the information processing method according to the second aspect, wherein in the effect amount adjusting process, the effect amount is reduced when the comparison result indicates that the degree of importance of the virtual sound image is lower than the degree of importance of the real sound image.

With this, when the comparison result indicates that the degree of importance of the virtual sound image is lower than the degree of importance of the real sound image, the effect amount can be adjusted to be reduced, that is, an output sound signal that makes the real sound image easier to perceive can be generated.

For example, an information processing method according to a fourth aspect of the present disclosure is the information processing method according to any one of the first to third aspects, wherein in the second obtaining process, information indicating that a trigger capable of generating the real sound image has been detected is obtained as the real sound image occurrence information.

With this, information indicating that a trigger capable of generating the real sound image has been detected is obtained as the real sound image occurrence information, and the degree of importance of the real sound image corresponding to the detected trigger indicated in the real sound image occurrence information can be compared with the virtual sound image.

For example, an information processing method according to a fifth aspect of the present disclosure is the information processing method according to any one of the first to third aspects, wherein in the second obtaining process, information indicating that the real sound image has been detected by sensing is obtained as the real sound image occurrence information.

With this, information indicating that a real sound image has been detected by sensing is obtained as the real sound image occurrence information, and the degree of importance of the detected real sound image indicated in the real sound image occurrence information can be compared with the virtual sound image.

For example, an information processing method according to a sixth aspect of the present disclosure is the information processing method according to any one of the first to fifth aspects, wherein in the second calculating process, the degree of importance of the real sound image is calculated based on a sound image object of the real sound image and a state of the sound image object.

With this, the degree of importance can be calculated based on the sound image object of the real sound image and a state of the sound image object, and in cases where the sound image object can take one or more states, the degree of importance can be individually calculated for each state. Stated differently, even when the real sound image is the same sound image object, the degree of importance of the virtual sound image can be compared by considering whether the sound image object is in a state of high degree of importance or in a state of low degree of importance.

For example, an information processing method according to a seventh aspect of the present disclosure is the information processing method according to the sixth aspect, wherein the sound image object is a person, and in the second calculating process, the degree of importance of the real sound image is calculated further based on a relationship of whether the person that is the sound image object and the user belong to a predetermined group.

With this, the degree of importance can be calculated based on the person that is the real sound image, a state of the person, and further a relationship of whether or not the person and the user belong to the same predetermined group, and in cases where the sound image object can take one or more states, the degree of importance can be individually calculated for each state. Furthermore, since it is possible to set whether or not the calculated degree of importance is important to the user based on the relationship between the person and the user, the degree of importance when the sound image object is a person can be calculated in a more realistic and flexible manner.

For example, an information processing method according to an eighth aspect of the present disclosure is the information processing method according to any one of the first to seventh aspects, wherein the second calculating process includes correcting the degree of importance of the real sound image calculated, using a correction coefficient dependent on a distance between a sound image object of the real sound image and the user, and in the comparing process, the degree of importance of the real sound image that has been corrected is used in the comparing.

With this, the influence that the distance has on the degree of importance can be reflected as a correction coefficient based on the distance between the sound image object and the user. Stated differently, the relative relationship between the degree of importance of the virtual sound image and the real sound image can be varied as the distance from the user increases or decreases.

For example, an information processing method according to a ninth aspect of the present disclosure is the information processing method according to any one of the first to eighth aspects, wherein in the effect amount adjusting process, the perception level of at least one of a sense of direction of the virtual sound image, a sense of spaciousness of the virtual sound image, or a sense of distance of the virtual sound image is adjusted.

With this, by adjusting the perception level of at least one of a sense of direction of the virtual sound image, a sense of spaciousness of the virtual sound image, or a sense of distance of the virtual sound image, it is possible to generate an output sound signal that makes the real sound image or the virtual sound image easier to perceive, making it possible to cause a user to perceive three-dimensional sound appropriately.

For example, an information processing method according to a tenth aspect of the present disclosure is the information processing method according to any one of the first to ninth aspects, wherein in the effect amount adjusting process, a first adjustment range and a second adjustment range are different, the first adjustment range being a difference between before and after adjustment of the effect amount adjusted in a first period, the second adjustment range being a difference between before and after adjustment of the effect amount adjusted in a second period different from the first period.

With this, the degree of adjustment of the effect amount can be varied between the first period and the second period. For example, even when the method determines to adjust the effect amount in the same way as the result of the comparing step, it becomes possible to perform processing such as significantly reducing the effect amount in the first period and reducing the effect amount by a smaller amount in the second period. There may be cases where a period in which there is not much need to adjust the effect amount can be set by the user, so in such cases, the present aspect is effective.

For example, an information processing method according to an eleventh aspect of the present disclosure is the information processing method according to any one of the first to tenth aspects, further including: a direction changing process of changing an arrival direction of sound from the virtual sound image to be perceived by the user.

With this, the arrival direction of sound from the virtual sound image can be changed, i.e., the position of the virtual sound image can be varied. Since this changes the relationship of the relative position with the real sound image, it enhances the ability to distinguish each of the real sound image and the virtual sound image. Therefore, an output sound signal that makes the real sound image and the virtual sound image easier to perceive can be generated.

For example, an information processing method according to a twelfth aspect of the present disclosure is the information processing method according to any one of the first to eleventh aspects, wherein in the effect amount adjusting process, the effect amount is increased when the comparison result indicates that the degree of importance of the virtual sound image is higher than the degree of importance of the real sound image.

With this, when the comparison result indicates that the degree of importance of the virtual sound image is higher than the degree of importance of the real sound image, the effect amount can be adjusted to be increased. In this case, since the degree of importance of the virtual sound image is higher than that of the real sound image, the virtual sound image should be perceived with higher priority. Therefore, this aspect reduces the possibility that the virtual sound image becomes difficult to perceive when the virtual sound image overlaps with the real sound image.

For example, an information processing method according to a thirteenth aspect of the present disclosure is the information processing method according to any one of the first to twelfth aspects, wherein in the effect amount adjusting process, an adjustment range is reduced as a number of times the user has listened to a sound image in the past increases, based on a listening log of the sound image of the user, the adjustment range being a difference between before and after adjustment of the effect amount adjusted in the effect amount adjusting process.

With this, based on a listening log of a sound image of the user, the degree of adjustment of the effect amount is reduced as the number of times the user has listened to the sound image in the past increases. More specifically, when the user has listened to that sound image many times, the possibility that the user can distinguish between the real sound image and the virtual sound image without adjustment of the effect amount increases. Accordingly, using how many times the user has listened to a sound image in the past as an indicator of ability to distinguish, the degree of adjustment of the effect amount is reduced according to that ability to distinguish. The output sound signal with adjusted effect amount may, of course, give the user a sense of discordance compared to when generating an output sound signal by processing the original sound information as is, so this aspect can reduce such discordance.

For example, an information processing device according to a fourteenth aspect of the present disclosure is for adjusting an output sound signal to cause a user to perceive a virtual sound image, and includes: a first obtainer that obtains sound information capable of identifying the virtual sound image to be perceived by the user via the output sound signal; a second obtainer that obtains real sound image occurrence information related to an occurrence of a real sound image which is a sound image in a real space where the user is located; a first calculator that calculates a degree of importance of the virtual sound image to be perceived by the user via the sound information obtained; a second calculator that calculates a degree of importance of the real sound image related to the real sound image occurrence information obtained; a comparator that compares the degree of importance of the virtual sound image calculated and the degree of importance of the real sound image calculated; and an effect amount adjuster that adjusts an effect amount indicating a perception level at which the user is to perceive the virtual sound image, based on a comparison result of the comparator.

With this, the same effects as the information processing method described above are achieved.

An acoustic reproduction system according to a fifteenth aspect of the present disclosure includes: the information processing device according to the fourteenth aspect; and a driver that reproduces the output sound signal generated.

With this, the output sound signal generated with the same effects as the information processing method described above is reproduced, making it possible to cause a user to perceive three-dimensional sound appropriately.

For example, a recording medium according to a sixteenth aspect of the present disclosure is a non-transitory computer-readable recording medium for use in a computer, the recording medium having a computer program recorded thereon for causing the computer to execute the information processing method according to any one of the first to thirteenth aspects.

With this, by executing the computer program recorded on the recording medium using a computer, the same effects as the information processing method described above are achieved.

Furthermore, these general or specific aspects may be implemented using a system, a device, a method, an integrated circuit, a computer program, or a non-transitory computer-readable recording medium such as a CD-ROM, or any combination thereof.

Hereinafter, one or more embodiments will be described in detail with reference to the drawings. Each embodiment described below presents a general or specific example. The numerical values, shapes, materials, elements, the arrangement and connection of the elements, steps, the processing order of the steps etc., shown in the following embodiment are mere examples, and do not limit the scope of the present disclosure. Among the elements described in the following one or more embodiments, those not recited in any of the independent claims are described as optional elements. Moreover, the figures are schematic diagrams and are not necessarily precise illustrations. In the figures, elements that are essentially the same share the same reference signs, and repeated description may be omitted or simplified.

In the following description, ordinal numbers such as first, second, etc., may be given to elements. These ordinal numbers are given to elements in order to distinguish the elements from each other, and thus do not necessarily correspond to an order that has intended meaning. Such ordinal numbers may be switched as appropriate, new ordinal numbers may be given, or the ordinal numbers may be removed.

### Embodiment

### Overview

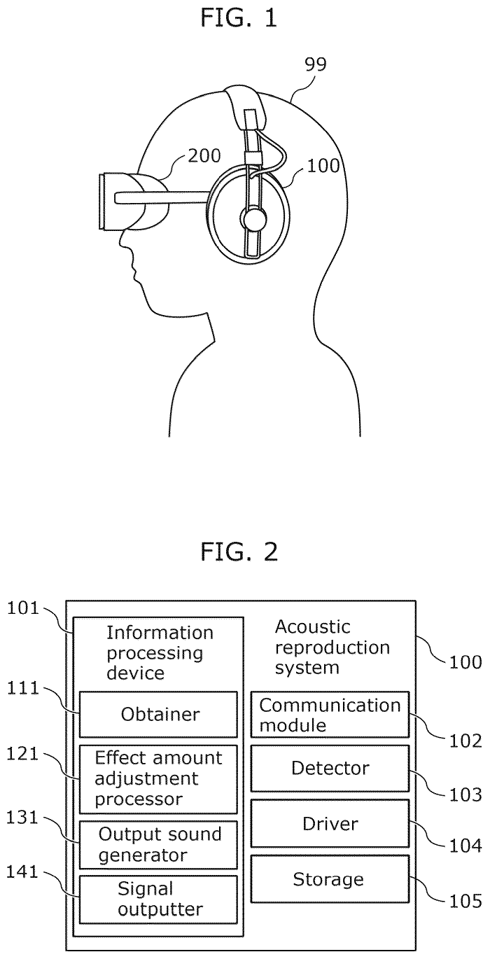

First, an overview of an acoustic reproduction system according to an embodiment will be described. FIG. 1 is a schematic diagram illustrating an example of use of an acoustic reproduction system according to the embodiment. FIG. 1 illustrates user 99 using acoustic reproduction system 100.

Acoustic reproduction system 100 illustrated in FIG. 1 is used simultaneously with stereoscopic image reproduction device 200. By simultaneously viewing stereoscopic images and listening to three-dimensional sound, the images enhance the auditory sense of realism, and the sound enhances the visual sense of realism, allowing one to experience as if being at the scene where the images and sound were captured. For example, when an image (moving image) of people having a conversation is displayed, even if the localization of the sound image of the conversation sound is misaligned with the person's mouth, it is known that user 99 perceives it as conversation sound emitted from the person's mouth. In this manner, by combining images and sound, the position of the sound image may be corrected by visual information, thereby enhancing the sense of realism.

Stereoscopic image reproduction device 200 is an image display device worn on the head of user 99. Accordingly, stereoscopic image reproduction device 200 moves integrally with the head of user 99. For example, stereoscopic image reproduction device 200 is, as illustrated in the figure, a glasses-type device supported by the ears and nose of user 99.

Stereoscopic image reproduction device 200 changes the image to be displayed in response to the movement of the head of user 99, to cause user 99 to perceive as if he or she is moving their head within a three-dimensional image space. Stated differently, when an object within the three-dimensional image space is positioned in front of user 99, if user 99 turns to the right, the object moves to the left direction of user 99, and if user 99 turns to the left, the object moves to the right direction of user 99. Thus, stereoscopic image reproduction device 200 moves the three-dimensional image space in the opposite direction to the movement of user 99.

Stereoscopic image reproduction device 200 displays two images with a parallax shift to the left and right eyes of user 99. User 99 can perceive the three-dimensional position of an object in the image based on the parallax shift of the displayed image. Note that when acoustic reproduction system 100 is used for the reproduction of healing sounds to induce sleep, or when user 99 uses it with their eyes closed, stereoscopic image reproduction device 200 does not need to be used simultaneously. Stated differently, stereoscopic image reproduction device 200 is not an essential element of the present disclosure.

Acoustic reproduction system 100 is an audio presentation device worn on the head of user 99. Accordingly, acoustic reproduction system 100 moves integrally with the head of user 99. For example, acoustic reproduction system 100 according to the present embodiment is what is known as an over-ear headphone device. Note that the embodiment of acoustic reproduction system 100 is not particularly limited and may be, for example, two in-ear devices independently worn on the left and right ears of user 99. These two devices communicate with each other to present right ear sound and left ear sound in synchronization.

Acoustic reproduction system 100 changes the sound to be presented in response to the movement of the head of user 99, to cause user 99 to perceive as if he or she is moving their head within a three-dimensional sound field. Thus, as described above, acoustic reproduction system 100 moves the three-dimensional sound field in the opposite direction to the movement of user 99.

Here, when sound images in content presented to a user, that is, virtual sound images, and sound images of external sound arriving from outside and heard by the user, that is, real sound images, mix together, it is known that user 99 finds it difficult to distinguish whether these sounds are virtual sound images or real sound images. Acoustic reproduction system 100 according to the present embodiment can make at least one of virtual sound images or real sound images easier to perceive by information processing to avoid this phenomenon, by adjusting the effect amount of virtual sound images. That is, acoustic reproduction system 100 makes either the virtual sound images or the real sound images easier for user 99 to perceive when virtual sound images and real sound images mix together. In such cases, the comparison result of the respective degrees of importance of the virtual sound images and the real sound images is used as a standard for adjustment.

### Structure

Next, a configuration of acoustic reproduction system 100 according to the present embodiment will be described with reference to FIG. 2. FIG. 2 is a block diagram illustrating the functional configuration of an acoustic reproduction system according to the embodiment.

As illustrated in FIG. 2, acoustic reproduction system 100 according to the present embodiment includes information processing device 101, communication module 102, detector 103, driver 104, and storage 105.

Information processing device 101 is a computing device for executing various types of signal processing in acoustic reproduction system 100. Information processing device 101 includes, for example, a processor and memory, and exhibits various functions by the processor executing a program stored in the memory.

Information processing device 101 includes obtainer 111, effect amount adjustment processor 121, output sound generator 131, and signal outputter 141. Each functional element included in information processing device 101 will be described in detail below along with details regarding configurations other than information processing device 101.

Communication module 102 is an interface device for receiving input of sound information to acoustic reproduction system 100. For example, communication module 102 includes an antenna and a signal converter, and receives sound information from an external device via wireless communication. More specifically, communication module 102 receives, via the antenna, a wireless signal indicating sound information converted into a format for wireless communication, and reconverts the wireless signal into sound information using the signal converter. In this way, acoustic reproduction system 100 obtains sound information from the external device via wireless communication. Sound information obtained by communication module 102 is obtained by obtainer 111. In this way, the sound information is input to information processing device 101. Communication between acoustic reproduction system 100 and the external device may be wired communication.

The sound information obtained by acoustic reproduction system 100 is, for example, encoded in a predetermined format such as MPEG-H 3D Audio (ISO/IEC 23008-3). As one example, encoded sound information includes information about a predetermined sound that is reproduced by acoustic reproduction system 100, and information about a localization position when the sound image of the sound is localized at a predetermined position in a three-dimensional sound field (i.e., the sound is perceived as arriving from a predetermined direction), that is, information about a predetermined position where a virtual sound image is located in the three-dimensional sound field. For example, the sound information includes information related to a plurality of sounds including a first predetermined sound and a second predetermined sound, and the sound images are localized so that when each sound is reproduced, the sound images are perceived as sounds arriving from different positions in a three-dimensional sound field.

This three-dimensional sound, for example, combined with images visually recognized using stereoscopic image reproduction device 200, can enhance the sense of realism of viewed and listened content. Note that the sound information may include only information about the predetermined sound. In such cases, information related to the predetermined position may be separately obtained. As described above, the sound information includes first sound information related to the first predetermined sound and second sound information related to the second predetermined sound, but a plurality of items of sound information separately including these may be obtained respectively and simultaneously reproduced to localize sound images at different positions in the three-dimensional sound field. Thus, the form of the input sound information is not particularly limited, and acoustic reproduction system 100 may include obtainer 111 corresponding to various forms of sound information.

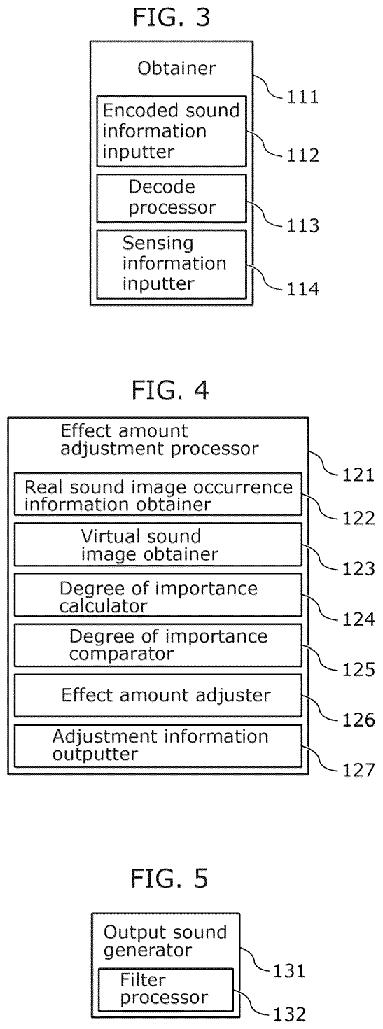

Here, one example of obtainer 111 will be described with reference to FIG. 3. FIG. 3 is a block diagram illustrating the functional configuration of an obtainer according to the embodiment. As illustrated in FIG. 3, obtainer 111 according to the present embodiment includes, for example, encoded sound information inputter 112, decode processor 113, and sensing information inputter 114.

Encoded sound information inputter 112 is a processor into which encoded sound information obtained by obtainer 111 is input. Encoded sound information inputter 112 outputs the input sound information to decode processor 113. Decode processor 113 is a processor that generates information related to predetermined sound included in the sound information and information related to a predetermined position in a format to be used in subsequent processing by decoding the sound information output from encoded sound information inputter 112. Sensing information inputter 114 will be described below along with the function of detector 103.

Detector 103 is for detecting the movement speed of the head of user 99. Detector 103 includes a combination of various sensors used for detecting movement, such as a gyro sensor and an acceleration sensor. In the present embodiment, detector 103 provided in acoustic reproduction system 100, but it may be provided in an external device, such as stereoscopic image reproduction device 200 that operates in response to the movement of the head of user 99, similarly to acoustic reproduction system 100. In such cases, detector 103 need not be included in acoustic reproduction system 100. Detector 103 may be an external imaging device or the like that captures images of the movement of the head of user 99, and the movement of user 99 may be detected by processing the captured images.

Detector 103 is, for example, integrally fixed to the housing of acoustic reproduction system 100, and detects the movement speed of the housing. Acoustic reproduction system 100 including the above-mentioned housing, after being worn by user 99, moves integrally with the head of user 99, and therefore detector 103 can detect the movement speed of the head of user 99.

Detector 103 may, for example, detect a rotation amount with at least one of three mutually orthogonal axes in three-dimensional space as a rotation axis, or detect a displacement amount with at least one of the three axes as a displacement direction, as an amount of movement of the head of user 99. Detector 103 may also detect both the rotation amount and the displacement amount as the amount of movement of the head of user 99.

Sensing information inputter 114 obtains the movement speed of the head of user 99 from detector 103. More specifically, sensing information inputter 114 obtains, as the movement speed, the amount of movement of the head of user 99 detected by detector 103 per unit time. In this way, sensing information inputter 114 obtains at least one of the rotation speed or the displacement speed from detector 103. Here, the amount of movement of the head of user 99 that is obtained is used to determine the coordinates and orientation of user 99 in the three-dimensional sound field. In acoustic reproduction system 100, sound is reproduced by determining the relative position of the sound image based on the determined coordinates and orientation of user 99. More specifically, the above-described functions are realized by output sound generator 131. Output sound generator 131 will be described later.

Effect amount adjustment processor 121 is a functional element that performs processing to adjust the effect amount of the virtual sound image. More specifically, effect amount adjustment processor 121 adjusts and determines the effect amount of the virtual sound image, and outputs information related to the adjusted effect amount to output sound generator 131. According to the information related to the effect amount, output sound generator 131 generates an output sound signal so that the virtual sound image is perceived at a perception level corresponding to the effect amount. Stated differently, since the output sound signal to be generated is also adjusted such that it has the adjusted effect amount, effect amount adjustment processor 121 can be considered to be adjusting the output sound signal. Here, one example of effect amount adjustment processor 121 will be described with reference to FIG. 4. FIG. 4 is a block diagram illustrating the functional configuration of the effect amount adjustment processor according to the embodiment.

Effect amount adjustment processor 121 includes real sound image occurrence information obtainer 122, virtual sound image obtainer 123, degree of importance calculator 124, degree of importance comparator 125, effect amount adjuster 126, and adjustment information outputter 127.

Real sound image occurrence information obtainer 122 is one example of a second obtainer, and is a processor that obtains real sound image occurrence information, which is information related to the occurrence of a real sound image in real space. As one example, real sound image occurrence information obtainer 122 obtains, as real sound image occurrence information, information indicating, for each real sound image in a list of sound images that can potentially generate real sound images in a real space that has been registered in advance, that a trigger that can cause each real sound image has been turned ON. In this example, regardless of whether a real sound image has actually occurred (regardless of whether sound has been emitted), if real sound image occurrence information indicating that a trigger has been turned ON is obtained, it is considered that the trigger has been detected and the real sound image corresponding to that trigger has occurred (that is, by identifying what the real sound image is as a sound image object linked to the trigger), and subsequent processing proceeds.

When real sound image occurrence information is obtained, a degree of importance is calculated for the real sound image corresponding to that trigger. This processing is performed by degree of importance calculator 124. Degree of importance calculator 124 is a processor that calculates a degree of importance for a real sound image when the real sound image occurs. Stated differently, degree of importance calculator 124 is one example of the second calculator. Degree of importance calculator 124 calculates by referencing information stored in storage 105 (to be described later), and reading out a degree of importance corresponding to the real sound image.

Real sound image occurrence information obtainer 122 may obtain the occurrence of the real sound image by sensing. More specifically, real sound image occurrence information obtainer 122 may obtain, as real sound image occurrence information, information indicating that a sound emitted by the real sound image has been detected by sensing. In this case as well, based on the sensed sound, it is possible to identify what the real sound image is by using existing technologies such as pattern matching, so degree of importance calculator 124 can calculate by referencing information stored in storage 105, and reading out a degree of importance corresponding to the real sound image.

When obtaining the occurrence of the real sound image by sensing, it is possible to calculate the degree of importance without identifying what the real sound image is. More specifically, even if the degree of importance corresponding to a real sound image is not stored in storage 105, degree of importance calculator 124 can still calculate the degree of importance of that real sound image based on its characteristics by applying a threshold test to the acoustic salience, thereby assigning a uniformly set, relatively high degree of importance (for example, a degree of importance higher than the degree of importance of any other real sound image in storage 105) to that real sound image. In this threshold test for acoustic salience, the determination is performed based on, for example, the sound pressure of the sensed sound being higher than a predetermined threshold, or when the sound is frequency-decomposed, power being concentrated at a predetermined frequency at or above a threshold.

The calculation of the degree of importance of the real sound image will be described in more detail later together with the explanation of operations performed by acoustic reproduction system 100.

Virtual sound image obtainer 123 is one example of the first obtainer, and is a processor that obtains sound information. Virtual sound image obtainer 123 in particular obtains information related to a predetermined sound from among the sound information, and provides it for the calculation of the degree of importance. In the sound information, virtual sound images in content to be reproduced are set in advance, i.e., it is possible to identify virtual sound images that are perceived by user 99 in the output sound signal when the output sound signal is generated and reproduced. The virtual sound image and the degree of importance of the virtual sound image are set by the content creator. Information associating a degree of importance for each virtual sound image is stored in storage 105. Degree of importance calculator 124 is a processor that calculates a degree of importance for a virtual sound image. Stated differently, degree of importance calculator 124 is one example of the first calculator. Degree of importance calculator 124 identifies which virtual sound image the predetermined sound of the obtained sound information belongs to, and calculates the degree of importance of the identified virtual sound image by referencing information stored in storage 105 and reading out the degree of importance corresponding to that virtual sound image.

Note that there may be cases where the virtual sound image is audio from a call within the virtual space. In this case, in the space at the other end of the call, sounds that are heard as real sound images are reproduced as sounds of virtual sound images through the call, so the degree of importance of the virtual sound image may be calculated using the same process as calculating the degree of importance for the real sound image mentioned above, namely, by obtaining information indicating that a trigger has been turned ON and calculating the degree of importance of the sound image corresponding to that trigger from information in storage 105, or by obtaining information indicating that a sound emitted by the sound image has been detected by sensing and calculating the degree of importance of that sound image from information in storage 105.

Degree of importance comparator 125 is one example of the comparator, and is a processor that compares the calculated degree of importance of the virtual sound image and the calculated degree of importance of the real sound image. Degree of importance comparator 125 outputs the comparison result to effect amount adjuster 126. When a comparison result is output, effect amount adjustment is performed to reduce the effect amount of the virtual sound image. Degree of importance comparator 125 may, for example, output a comparison result indicating that the degree of importance of the virtual sound image is lower than or equal to the degree of importance of the real sound image, or output a comparison result indicating that the degree of importance of the virtual sound image is lower than the degree of importance of the real sound image. In the former case, even if the degree of importance of the virtual sound image is the same as the degree of importance of the real sound image, since the effect amount of the virtual sound image is reduced, it can be said that the user can more easily perceive the real sound image. However, in the latter case, when the degree of importance of the virtual sound image is the same as the degree of importance of the real sound image, since the effect amount of the virtual sound image is not reduced, it can be said that the user can more easily perceive the virtual sound image.

Alternatively, degree of importance comparator 125 may output a comparison result indicating that the degree of importance of the virtual sound image is greater than the degree of importance of the real sound image. In such cases, the effect amount of the virtual sound image is adjusted by considering not only whether a comparison result is output or not, but also what kind of comparison result is output. For example, when a comparison result indicating that the degree of importance of the virtual sound image is greater than the degree of importance of the real sound image is output, effect amount adjustment is performed to increase the effect amount of the virtual sound image. By doing so, when the degree of importance of the virtual sound image is greater, that is, when there is a lower necessity to perceive the real sound image, the effect amount of the virtual sound image can be increased to enhance immersion.

As described above, effect amount adjuster 126 is a processor that adjusts the effect amount of the virtual sound image based on the comparison result of the degree of importance by the degree of importance comparator 125. More specifically, effect amount adjuster 126 determines whether to adjust the effect amount, determines the direction of adjustment (whether to reduce or increase the effect amount of the virtual sound image) and the adjustment range (corresponding to the difference before and after the adjustment of the effect amount), and generates adjustment information for the adjustment.

Adjustment information outputter 127 outputs the adjustment information generated by effect amount adjuster 126 to output sound generator 131.

Output sound generator 131 is a processor that generates an output sound signal that causes a virtual sound image with an adjusted effect amount to be perceived, by inputting information related to predetermined sound included in the sound information to a three-dimensional sound filter corresponding to the adjustment information output from effect amount adjustment processor 121, based on the adjustment information.

Here, one example of output sound generator 131 will be described with reference to FIG. 5. FIG. 5 is a block diagram illustrating the functional configuration of the output sound generator according to the embodiment. As illustrated in FIG. 5, output sound generator 131 according to the present embodiment includes, for example, filter processor 132. Filter processor 132 sequentially reads a three-dimensional sound filter corresponding to the adjustment information output from effect amount adjustment processor 121, and by inputting information related to predetermined sound corresponding to the time axis, continuously outputs an output sound signal that is perceived as a virtual sound image with an adjusted effect amount, in which the arrival direction of the predetermined sound in the three-dimensional sound field is controlled. In this way, sound information divided into processing unit time intervals on the time axis is output as a continuous output sound signal on the time axis.

Signal outputter 141 is a functional element that outputs the generated output sound signal to driver 104. Signal outputter 141 generates a waveform signal by performing digital-to-analog signal conversion based on the output sound signal, causes driver 104 to generate sound waves based on the waveform signal, and presents sound to user 99. Driver 104 includes, for example, a diaphragm and a driving mechanism such as a magnet and a voice coil. Driver 104 operates the driving mechanism in accordance with the waveform signal, and causes the diaphragm to vibrate via the driving mechanism. In this way, driver 104 generates sound waves by vibrating the diaphragm in accordance with the output sound signal (meaning to “reproduce” the output sound signal, that is, whether or not user 99 perceives it is not included in the meaning of “reproduction”), the sound waves propagate through the air and are transmitted to user 99's ears, and user 99 perceives the sound.

Storage 105 is a device for storing information, realized by semiconductor memory or the like. As described above, storage 105 stores information related to the calculation of the degree of importance. Information related to the calculation of the degree of importance stored in storage 105 will be described later together with the explanation of operations performed by acoustic reproduction system 100.

### Operations

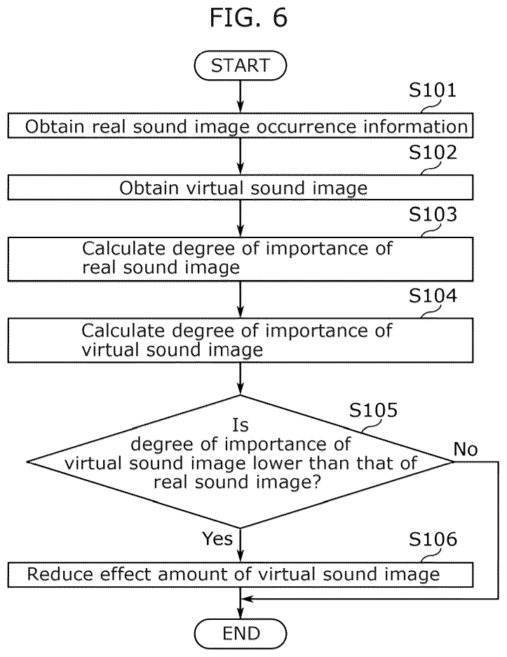

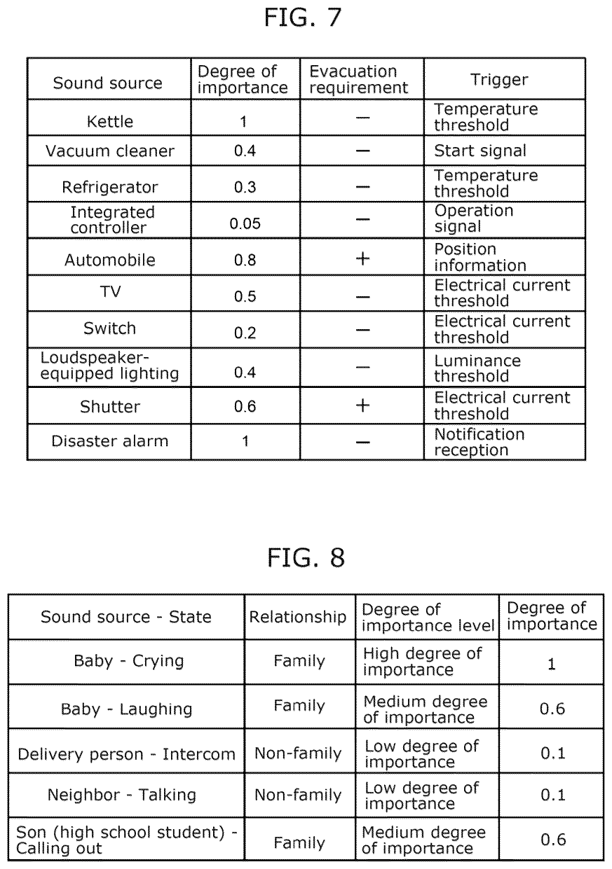

Next, operations performed by acoustic reproduction system 100 described above will be explained with reference to FIG. 6 through FIG. 10. FIG. 6 is a flowchart illustrating operations performed by an acoustic reproduction system according to an embodiment. FIG. 7 through FIG. 10 are diagrams for explaining calculation of the degree of importance according to the embodiment. First, when operation of acoustic reproduction system 100 is started, obtainer 111 obtains sound information via communication module 102. The sound information is decoded by decode processor 113 into information related to a predetermined sound and information related to a predetermined direction, and adjustment of the effect amount is started.

In effect amount adjustment processor 121, an operation of obtaining real sound image occurrence information is started, and the information is obtained when various triggers are turned ON (second obtaining step S101). For example, as illustrated in FIG. 7 (second line), when the real sound image is a kettle and boiling sound of that kettle is occurring, the trigger is turned ON when the detection result of the temperature sensor inside the kettle exceeds a temperature threshold, and trigger information is obtained.

Virtual sound image obtainer 123 obtains a virtual sound image in the content that the user is reproducing at this time (first obtaining step S102).

Degree of importance calculator 124 calculates the degree of importance of the real sound image by referencing storage 105 (second calculating step S103), and calculates the degree of importance of the virtual sound image (first calculating step S104). Second obtaining step S101 to first calculating step S104 may be executed with their order interchanged.

Here, in the calculation of the degree of importance of the real sound image, the degree of importance may be set based on a sound image object of the real sound image and a state of the sound image object. Stated differently, in the calculation of the degree of importance of the real sound image, the degree of importance may be calculated based on a sound image object of the real sound image and a state of the sound image object. Furthermore, the sound image object may be a person, and the degree of importance may be set further based on a relationship of whether the person that is the sound image object and the user belong to a predetermined group. Stated differently, the degree of importance may be calculated further based on a relationship of whether the person that is the sound image object and the user belong to a predetermined group.

More specifically, as illustrated in FIG. 8, each sound image object may be a person, such as a baby, a delivery person, a neighbor, or a son (high school student). A relationship with the user can be set for these people, and for example, when the relationship indicates that they belong to a group called family with the user, a higher degree of importance may be set compared to when the same person does not belong to the family group. Note that family is one example of a predetermined group, and other predetermined groups may be arbitrarily set, such as being in the same class, living in the same region, etc.

FIG. 8 also illustrates that the degree of importance differs depending on the state of the person that is the sound source object. More specifically, even for the same sound source object—a baby—the state differs between the second row and the third row as to whether it is crying or laughing, and a higher degree of importance is set for the crying state compared to the laughing state. In this way, the degree of importance of the real sound image may be calculated based on the sound source object and the state thereof.

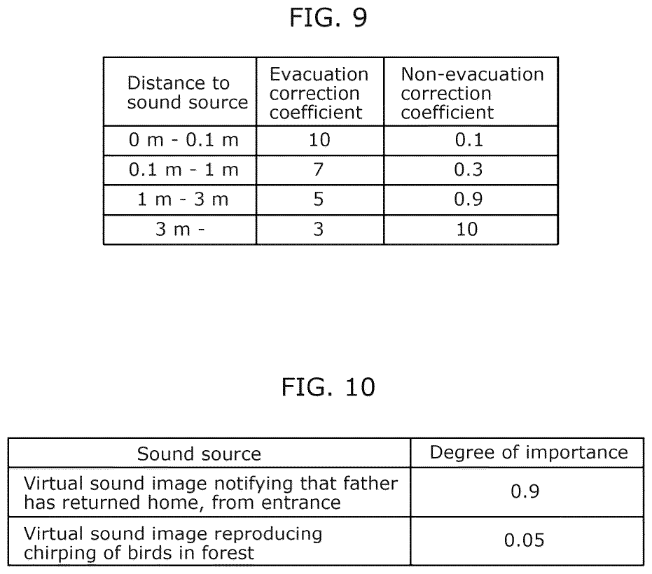

In the calculation of the degree of importance of the real sound image, if the necessity of evacuation when a sound occurs is set for each real sound image, such information can also be used in the calculation of the degree of importance of the real sound image. For example, as illustrated in the third column in FIG. 7, each real sound image is associated with information indicating whether evacuation is necessary or not when the sound occurs, namely evacuation required is denoted as “+” and evacuation not required is denoted as “−”. Here, if a sound is emitted from the real sound image, for those requiring evacuation, it is necessary to move away from the position of the sound image. Here, as illustrated in FIG. 9, by using a correction coefficient dependent on a distance based on whether evacuation is required or not required and the distance from the user to the position of the sound image, the degree of importance of each real sound image can be corrected to an appropriate degree of importance according to the necessity of evacuation and the current distance from the user. Regarding the method of correcting the degree of importance, for example, when there is a degree of importance α before correction and correction coefficient β, the degree of importance α′ after correction can be calculated based on any of the following four equations.

$${a}^{′} = a \times β \qquad ( Equation 1 )$$

$${a}^{′} = a ( 1 + β ) \qquad ( Equation 2 )$$

$${a}^{′} = {a}^{( 1 + β )} \qquad ( Equation 3 )$$

$${a}^{′} = a + β \qquad ( Equation 4 )$$

Note that Equations 1 and 3 tend to apply a stronger influence from the correction coefficient, while Equations 2 and 4 tend to apply a more moderate influence. Furthermore, in addition to the above four equations, any equation and correction coefficient may be used as long as an appropriate formula and correction coefficient are set according to the conditions of the degree of importance to be applied.

For example, taking Equation 1 as an example, since the kettle does not require evacuation, when the distance is 0.05 m, the degree of importance can be corrected from the pre-correction degree of importance of 1 to 0.1 by using a correction coefficient of 0.1. In contrast, since the automobile requires evacuation, when the distance is 0.05 m, the degree of importance can be corrected from the pre-correction degree of importance of 0.8 to 8 by using a correction coefficient of 10. In the present example, the degree of importance of the real sound image after being corrected in this manner is provided for comparison with the degree of importance of the virtual sound image.

Degree of importance calculator 124 also calculates the degree of importance for each of the obtained virtual sound images by referencing storage 105. Storage 105 stores information in which each virtual sound image, such as those illustrated in FIG. 8, is associated with a degree of importance.

Note that the degree of importance illustrated in FIG. 8 is introduced by being commonly set based on empirical measurements or experimental results when manufacturing acoustic reproduction system 100, but the degree of importance may also be configured to be arbitrarily settable by an administrator of acoustic reproduction system 100. For example, if the user (listener) of acoustic reproduction system 100 is a son (high school student) who is not in a position (role) to care for a baby, the degree of importance of the baby may be set to 0.1 or 0.0. After setting a high degree of importance for a baby, when the baby grows into a toddler, elementary school student, or junior high school student over time, it is desirable to change the degree of importance from that of a baby to one corresponding to a toddler, elementary school student, or junior high school student, in accordance with the child's growth. Additionally, since various settings of the degree of importance are assumed from the position (role) of the user of acoustic reproduction system 100, it is sufficient if the degree of importance, such as that illustrated in FIG. 8, can be appropriately set by an administrator or the like according to the position (role) of the user of acoustic reproduction system 100. The degree of importance as illustrated in FIG. 7 is introduced by being commonly set based on empirical measurements or experimental results when manufacturing acoustic reproduction system 100, but the degree of importance may be appropriately set according to the position (role) of the user of acoustic reproduction system 100. Acoustic reproduction system 100 may include a setting unit (not illustrated in the drawings) used for such arbitrary settings.

Returning to FIG. 6, degree of importance comparator 125 compares whether the degree of importance of the virtual sound image is low relative to the real sound image (comparing step S105). When the degree of importance of the virtual sound image is low relative to the real sound image (Yes in S105), the effect amount is adjusted so as to reduce the effect amount of the virtual sound image (effect amount adjusting step S106). When the degree of importance of the virtual sound image is high relative to the real sound image (No in S105), the effect amount of the virtual sound image is not adjusted, and the process ends. Alternatively, when the degree of importance of the virtual sound image is high relative to the real sound image (No in S105), the effect amount may be adjusted so as to increase the effect amount.

In this way, when adjustment information is generated and output, output sound generator 131, through filter processor 132, reads a three-dimensional sound filter corresponding to the adjustment information output from effect amount adjustment processor 121, which adjusts a perception level of at least one of a sense of direction of the virtual sound image, a sense of spaciousness of the virtual sound image, or a sense of distance of the virtual sound image, and processes the predetermined sound of the sound information to generate an output sound signal.

In such cases, the adjustment range, i.e., the difference between before and after adjustment of the effect amount, may be configured to be different between a certain period and other periods among periods such as one day, one week, or one month. For example, the adjustment range may be configured to be smaller during daytime, nighttime, weekends, or mid-month compared to early morning, evening, weekdays, beginning of the month, or end of the month. In this way, the adjustment information may be generated such that a first adjustment range, which is the difference between before and after adjustment of the effect amount adjusted in a first period, and a second adjustment range, which is the difference between before and after adjustment of the effect amount adjusted in a second period different from the first period, are different.

Additionally, in cases where the user is accustomed to a sound image because the user has perceived the same virtual sound image in the past, or the user has perceived the same real sound image in the past, the adjustment range may be expanded or contracted. More specifically, based on a listening log of a sound image (in this case, either a real sound image or a virtual sound image) of the user, the effect amount adjusting process may reduce the adjustment range, i.e., the difference between before and after adjustment of the effect amount adjusted in the effect amount adjusting process, as the number of times the user has listened to the sound image in the past increases.

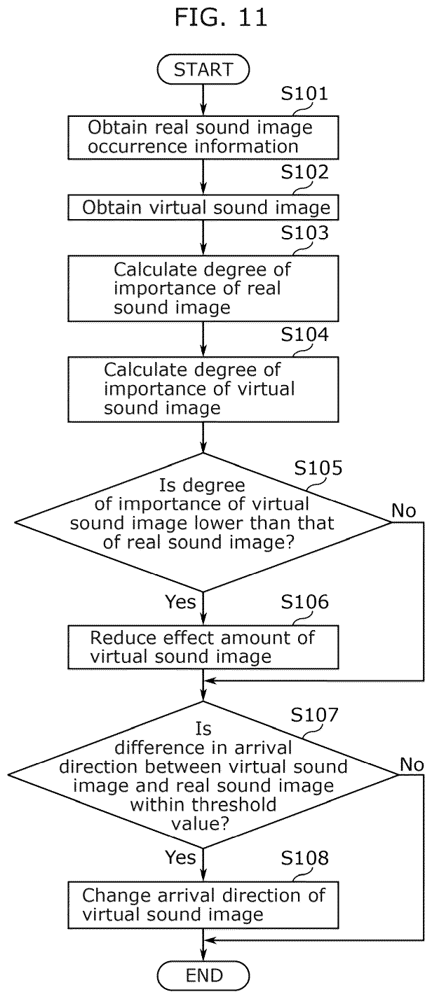

Hereinafter, another example of the embodiment will be described with reference to FIG. 11. FIG. 11 is a flowchart illustrating operations performed by an information processing device according to another example of the embodiment. FIG. 11 differs from the flowchart illustrated in FIG. 6 in that step S107 and changing step S108 are added. Accordingly, for the explanation of the second obtaining step S101 to the effect amount adjusting step S106, reference is made to the explanation in FIG. 6, so repeated explanation here is omitted.

After the effect amount adjusting step S106, or after No is determined in the comparing step S105, it is determined whether a difference in arrival direction between the virtual sound image and the real sound image is within a threshold value (S107). When it is determined that the difference in arrival direction between the virtual sound image and the real sound image is within the threshold value (Yes in S107), a three-dimensional sound filter is further selected so as to change the arrival direction of the virtual sound image (changing step S108). In this way, after adjusting the effect amount of the virtual sound image to make the virtual sound image or the real sound image easier to perceive, further, for combinations where the arrival direction of the real sound image and the virtual sound image are close, the arrival direction of the sound can be changed to create an offset, thereby making the virtual sound image or the real sound image even easier to perceive. Note that when it is determined that the difference in arrival direction between the virtual sound image and the real sound image is greater than the threshold value (No in S107), the process ends without performing the changing step S108.

### Other Embodiments

While exemplary embodiments have been described above, the present disclosure is not limited to the above-described embodiments.

For example, in the above embodiment, an example where sound does not follow the movement of the head of the user was described, but the content of the present disclosure is also effective in cases where sound follows the movement of the head of the user. Stated differently, within the operation of causing the user to perceive a predetermined sound as arriving from a first position that moves relatively with the movement of the head of the user, when the type of the predetermined sound and the type of the external sound match, and the arrival directions overlap or the like, the three-dimensional sound filter may be changed to improve the identifiability of at least one of them.

For example, the acoustic reproduction system described in the above embodiments may be implemented as a single device including all elements, or may be implemented by a plurality of devices, with each function allocated to the devices and these devices cooperating with each other. In the latter case, an information processing device such as a smartphone, tablet terminal, or personal computer (PC) may be used as a device corresponding to the information processing device.

In the above embodiments, processing executed by a specific processor may be executed by another processor. The order of a plurality of processes may be changed, and a plurality of processes may be executed in parallel.

Moreover, in the above embodiments, each element may be realized by executing a software program suitable for the element. Each of the elements may be realized by means of a program executing unit, such as a central processing unit (CPU) or a processor, reading and executing the software program recorded on a recording medium such as a hard disk or a semiconductor memory.

Each of the structural elements may be implemented by hardware. For example, each element may be a circuit (or an integrated circuit). These circuits may constitute one circuit as a whole, or may be separate circuits. These circuits may each be a general-purpose circuit or a dedicated circuit.

General or specific aspects of the present disclosure may be realized as a device, a method, an integrated circuit, a computer program, or a computer-readable recording medium such as a CD-ROM. General or specific aspects of the present disclosure may be realized as any given combination of a device, an apparatus, a method, an integrated circuit, a computer program, and a recording medium.

For example, the present disclosure may be implemented as an audio signal reproduction method executed by a computer, or may be implemented as a program for causing a computer to execute an audio signal reproduction method. The present disclosure may be implemented as a computer-readable non-transitory recording medium having the program recorded thereon.

Embodiments arrived at by a person skilled in the art making various modifications to any one of the embodiments, or embodiments realized by arbitrarily combining elements and functions in the embodiments which do not depart from the essence of the present disclosure are also included in the present disclosure.

### INDUSTRIAL APPLICABILITY

The present disclosure is useful for acoustic reproduction, such as causing a user to perceive three-dimensional sound.

1. An information processing method for adjusting an output sound signal to cause a user to perceive a virtual sound image, the information processing method comprising:
a first obtaining process of obtaining sound information capable of identifying the virtual sound image to be perceived by the user via the output sound signal;
a second obtaining process of obtaining real sound image occurrence information related to an occurrence of a real sound image which is a sound image in a real space where the user is located;
a first calculating process of calculating a degree of importance of the virtual sound image to be perceived by the user via the sound information obtained;
a second calculating process of calculating a degree of importance of the real sound image related to the real sound image occurrence information obtained;
a comparing process of comparing the degree of importance of the virtual sound image calculated and the degree of importance of the real sound image calculated; and
an effect amount adjusting process of adjusting an effect amount indicating a perception level at which the virtual sound image is to be perceived by the user, based on a comparison result of the comparing process.

2. The information processing method according to claim 1, wherein
in the effect amount adjusting process, the effect amount is reduced when the comparison result indicates that the degree of importance of the virtual sound image is lower than or equal to the degree of importance of the real sound image.

3. The information processing method according to claim 2, wherein
in the effect amount adjusting process, the effect amount is reduced when the comparison result indicates that the degree of importance of the virtual sound image is lower than the degree of importance of the real sound image.

4. The information processing method according to claim 1, wherein
in the second obtaining process, information indicating that a trigger capable of generating the real sound image has been detected is obtained as the real sound image occurrence information.

5. The information processing method according to claim 1, wherein
in the second obtaining process, information indicating that the real sound image has been detected by sensing is obtained as the real sound image occurrence information.

6. The information processing method according to claim 1, wherein
in the second calculating process, the degree of importance of the real sound image is calculated based on a sound image object of the real sound image and a state of the sound image object.

7. The information processing method according to claim 6, wherein
the sound image object is a person, and
in the second calculating process, the degree of importance of the real sound image is calculated further based on a relationship of whether the person that is the sound image object and the user belong to a predetermined group.

8. The information processing method according to claim 1, wherein
the second calculating process includes correcting the degree of importance of the real sound image calculated, using a correction coefficient dependent on a distance between a sound image object of the real sound image and the user, and
in the comparing process, the degree of importance of the real sound image that has been corrected is used in the comparing.

9. The information processing method according to claim 1, wherein
in the effect amount adjusting process, the perception level of at least one of a sense of direction of the virtual sound image, a sense of spaciousness of the virtual sound image, or a sense of distance of the virtual sound image is adjusted.

10. The information processing method according to claim 1, wherein
in the effect amount adjusting process, a first adjustment range and a second adjustment range are different, the first adjustment range being a difference between before and after adjustment of the effect amount adjusted in a first period, the second adjustment range being a difference between before and after adjustment of the effect amount adjusted in a second period different from the first period.

11. The information processing method according to claim 1, further comprising:
a direction changing process of changing an arrival direction of sound from the virtual sound image to be perceived by the user.

12. The information processing method according to claim 1, wherein
in the effect amount adjusting process, the effect amount is increased when the comparison result indicates that the degree of importance of the virtual sound image is higher than the degree of importance of the real sound image.

13. The information processing method according to claim 1, wherein
in the effect amount adjusting process, an adjustment range is reduced as a number of times the user has listened to a sound image in the past increases, based on a listening log of the sound image of the user, the adjustment range being a difference between before and after adjustment of the effect amount adjusted in the effect amount adjusting process.

14. An information processing device for adjusting an output sound signal to cause a user to perceive a virtual sound image, the information processing device comprising:
a first obtainer that obtains sound information capable of identifying the virtual sound image to be perceived by the user via the output sound signal;
a second obtainer that obtains real sound image occurrence information related to an occurrence of a real sound image which is a sound image in a real space where the user is located;
a first calculator that calculates a degree of importance of the virtual sound image to be perceived by the user via the sound information obtained;
a second calculator that calculates a degree of importance of the real sound image related to the real sound image occurrence information obtained;
a comparator that compares the degree of importance of the virtual sound image calculated and the degree of importance of the real sound image calculated; and
an effect amount adjuster that adjusts an effect amount indicating a perception level at which the user is to perceive the virtual sound image, based on a comparison result of the comparator.

15. An acoustic reproduction system comprising:
the information processing device according to claim 14; and
a driver that reproduces the output sound signal generated.

16. A non-transitory computer-readable recording medium for use in a computer, the recording medium having a computer program recorded thereon for causing the computer to execute the information processing method according to claim 1.
